(19) United States
(12) Patent Application Publication
(10) Pub. No.: US 2017/0179987 A1
(43) Pub. Date: Jun. 22, 2017

(54) EMBEDDED PORT IN WEARABLE MOBILE ELECTRONIC DEVICE

(71) Applicant: Intel Corporation, Santa Clara, CA (US)

(72) Inventor: John G. Meyers, Sacramento, CA (US)

(21) Appl. No.: 14/974,654

(22) Filed: Dec. 18, 2015

(51) Int. Cl. H04B 1/3827; H04M 1/02

(52) U.S. Cl. CPC H04B 1/385; H04M 1/0274

(57) ABSTRACT

A mobile device with the band having a first end coupled with the mobile device to affix the mobile device to an object, such as a wrist, and the connector port disposed at a second end of the band and electrically coupled with the mobile device, to provide a charge to the mobile device in response to a plug-in of the connector port into a charging device. Other embodiments may be described and/or claimed.

### FIELD

Embodiments of the present disclosure generally relate to the field of mobile and/or wearable electronic devices, in particular to the charging of these devices.

### BACKGROUND

Over the last several years there has been an explosion in the number of wearable electronic devices that need charging and/or transfer data from the device to a host. These devices may frequently use a cable that attaches to the wearable device to re-charge the battery in the device, and/or to transmit or to receive data from the device to or from a host device. The cables may be cumbersome to bring with the wearable device, and when lost, may degrade the usability of the wearable device.

### BRIEF DESCRIPTION OF THE DRAWINGS

FIG. 1 illustrates an example view of a band having a connector to charge a wireless device removably attached to the band, in accordance with some embodiments.

FIG. 2 illustrates a flowchart describing a method for fabricating an embedded port in wearable electronic device, in accordance with some embodiments.

FIG. 3 schematically illustrates a computing device incorporating at least some aspects of the embodiments described herein, in accordance with some embodiments.

### DETAILED DESCRIPTION

Embodiments of the present disclosure generally relate to data communication and battery charging method and apparatus for wearable electronic devices. In particular, a power and/or data connector, such as a universal serial bus (USB) connection, may be attached to an end of a wrist strap. The power and data connector may be electrically connected to a wearable device via the wrist strap. The device may be chargeable without the use of an extra power cord, by plugging the connection directly into a USB port. In embodiments, after connection into a USB port, communication may occur between a device and another device that may be connected to the USB port.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or elements are in direct contact.

Various operations may be described as multiple discrete operations in turn, in a manner that is most helpful in understanding the claimed subject matter. However, the order of description should not be construed as to imply that these operations are necessarily order dependent.

One embodiment may include a mobile device with the band having a first end coupled with the mobile device to affix the mobile device to an object, and the connector port disposed at a second end of the band and electrically coupled with the mobile device, to provide a charge to the mobile device in response to a plug-in of the connector port into a charging device.

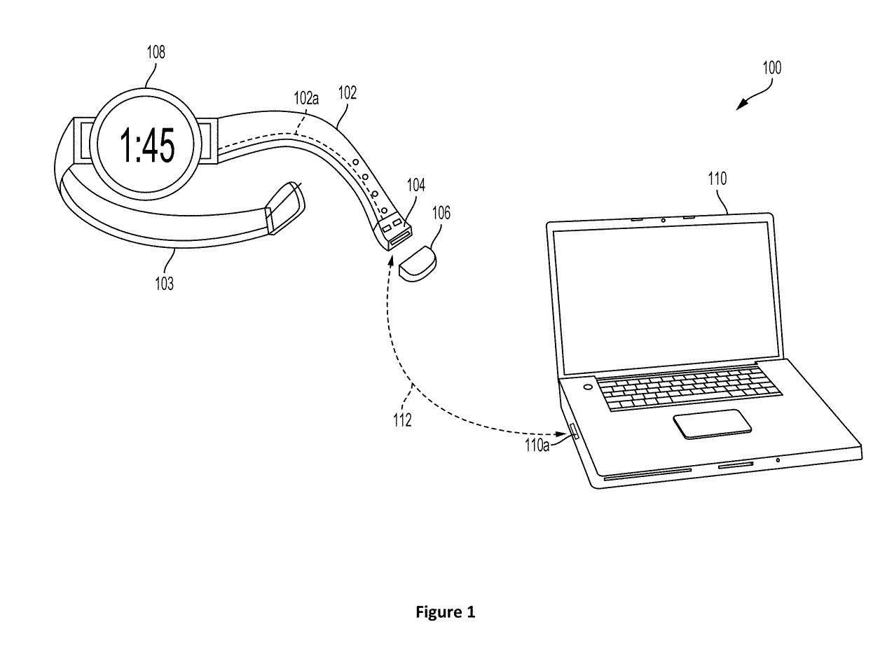

FIG. 1 illustrates an example view of a band having a connector to charge a wireless device removably attached to the band, and provide communication capabilities with another device, in accordance with some embodiments. Wearable devices may have different band types and different ways of charging the device. For example, the band may be used as a wrist strap to secure the wearable device to a wrist of a person wearing the wearable device. In other embodiments, the wrist strap may be used as a strap or band to attach the wearable device to another body part such as a person's head, neck, leg, ankle band, or other such part. In embodiments, the wrist strap may be used to attach the wearable device to an article of clothing such as a belt loop, a backpack loop, a buttonhole or some other such feature of an article of clothing, or attachment to an article of clothing. In embodiments, the strap may be used to attach the wearable device to an animal, in non-limiting examples including a dog collar, a cat collar, an animal tag, or other similar wearable device for an animal. In embodiments, the strap may also be used to attach a wearable device to tangible personal property, non-limiting examples including an identification device attached to luggage for travel, or a tracking device attached to a backpack.

Wearable devices having a band that goes around the wrist may use separate magnetic charging device with a cable that attaches to the magnetic receiving area for inductive charging. In other examples, devices may plug-in area at or near the device into which a separate cable having a USB connector on the end may be plugged into a USB receptacle.

Diagram 100 of FIG. 1 shows a non-limiting example of a band 102 having a port 104, attached to the end of the band. In embodiments, electrical connections 102a may exist within the band 102 to electrically connect the port 104 to a wearable device 108. These connections 102a may allow the wearable device 108 and a charger device 110 to which the band 102 may be connected via charging/data port 110a, to charge a battery (not shown) within the wearable device 108, and/or allow data communication between the wearable device 108 and the charger device 110.

In some embodiments, the band 102 may be made of any material suitable for attaching to a wearable electronic device. The material making up the band 102 may include cloth, nylon, rayon, cotton (or any other natural fiber), plastic, carbon fiber, or metal. In some embodiments, the band 102 may be fixed and non-bendable, in non-limiting examples including a single-formed piece of hard plastic, carbon fiber, or metal. In some embodiments, the band 102 may be flexible. This flexibility may come from using flexible materials such as, but not limited to, elastic polymers and other stretchable fabrics such as Lycra, latex, spandex, and other stretch fabrics. In some embodiments, band 102 flexibility may come from hybrid compositions between fixed material and flexible materials.

In some embodiments, a second band 103 may be used to attach the wearable device 108 with the band 102, which may provide a loop to securely attach the wearable device 108 to a user. In one non-limiting example, the second band may attach to the band 102 in a way similar to a traditional watchband, in order to keep the wearable device 108, in this example watch, secure to the user's wrist.

In some embodiments, the electrical connection within the band 102 from the wearable device 108 to the port 104 may be implemented in any suitable way to allow electrical charge and/or electrical signals to move through the band 102. In some embodiments, this may be done through one or more wires 102a that are within the band 102, and that connect with the wearable device 108 and the port 104. In embodiments, these wires may be included within the band in such a way to be able to stretch and/or twist as the band 102 may stretch and/or twist during the attachment, use, and detachment of the wearable device 108 by the user without degrading or breaking the electrical connection between the port 104 and the wearable device 108.

In some embodiments, the port 104 may include a connection that may be a fixed, twisted, bendable, retractable, and/or compressible connection when it is connected, as shown in connection 112, to charging/data port 110a of the charging device 110, such as a computing device. In some embodiments, the port 104 may extend from and/or retract into the band 102 to allow a connection with a charging/data port 110a. This may allow a user, in a non-limiting example, to charge the wearable device 108 while it remains attached to the user's wrist.

In some embodiments, the type of communication between the wearable device 108 and the port 104 may include any suitable communication standard, including, but not limited to, serial connection, parallel connection, a bus connection, fiber-optic connection, and the like that may be used for charging the wearable device 108 and/or data communication between the wearable device 108 and the port 104. In some embodiments, the port 104 may be USB-compliant, secure digital, SD, compliant, peripheral component interconnect express, PCIe, compliant, fiber channel AT attachment, FATA, compliant, Thunderbolt® compliant, or compliant with some other communication and/or charging configuration.

In some embodiments, during use to charge and/or provide data communication with the wearable device 108, the port 104 may be plugged directly into the charging/data port 110a, without requiring any additional connection cables between the port 104 and the charging port 110a.

In some embodiments, a port protection device 106 may be attached to the port 104 in order to partially or fully cover or the port 104. In some embodiments, the port protection device 106 may be inserted into the port 104, or may be partially inserted and/or may partially cover the port 104.

In some embodiments, the port protection device 106 may protect the port 104 from damage, or may keep foreign objects such as dirt, sand, and/or dust from entering the port 104, which may cause it from correctly seating into, and/or properly electrically connecting to the charging/data port 110a that is a part of the charging device 110. In addition, the port protection device 106 may provide additional comfort for the wearer of the device, for example, to prevent the connector 104 from coming into contact with the skin of the wearer. In embodiments, the port protection device 106 may be attached to the band 102 via a lanyard or similar connector.

In some embodiments, the port 104 may include functionality to provide an identification mechanism to identify the wearable device 108 to the charging device 110. Such mechanism may be implemented in mechanical design, firmware, hardware, software, or a combination thereof. In some embodiments, this identification mechanism may be used to determine types of communication allowed between the wearable device 108 and the charging device 110 when they are connected by inserting port 104 into charging/data port 110a. In some embodiments, this identification mechanism may be used to either disable or prevent the communication connection and/or charging connection between the wearable device 108 and the charging device 110. In some embodiments, the identification mechanism may be used to identify the wearable device 108 to the charging device 110.

In some embodiments, the port 104 may include functionality to identify the charging/data port 110a and/or the charging device 110 to the wearable device 108. This functionality may be in firmware, hardware, software, and/or other identification system. This functionality may be used to determine whether communications transmission ability may be established between the wearable device 108 and the charging device 110. This functionality may also be used to determine whether the electrical coupling between the port 104 and charging/data port 110a may be disconnected, for example, for security reasons.

Some embodiments of a mechanical identification system may include the port 104 and charging/data port 110a having a unique mechanical interface like a key and lock, restricting the ability to charge the wearable device 108 and/or transfer data to and from the wearable device 108. Some embodiments of a hardware solution may use specific clock frequencies and/or voltages to control the operation of device port 104 or charging/data port 110a. Some embodiments of a software solution may use an encryption method, password combinations, or electronic communications such as text or emails to control connectivity between port 104 and the charging/data port 110a. Some embodiments of a hardware and/or software solution may use information gathered by the wearable device 108, including but not limited to biometric information, such as body temperature, blood pressure, fingerprints, v, heartbeat patterns, voice, unique movements (such as a limp or gait) and other biometric characteristics to verify a user and to control connectivity between port 104 and the charging/data port 110a.

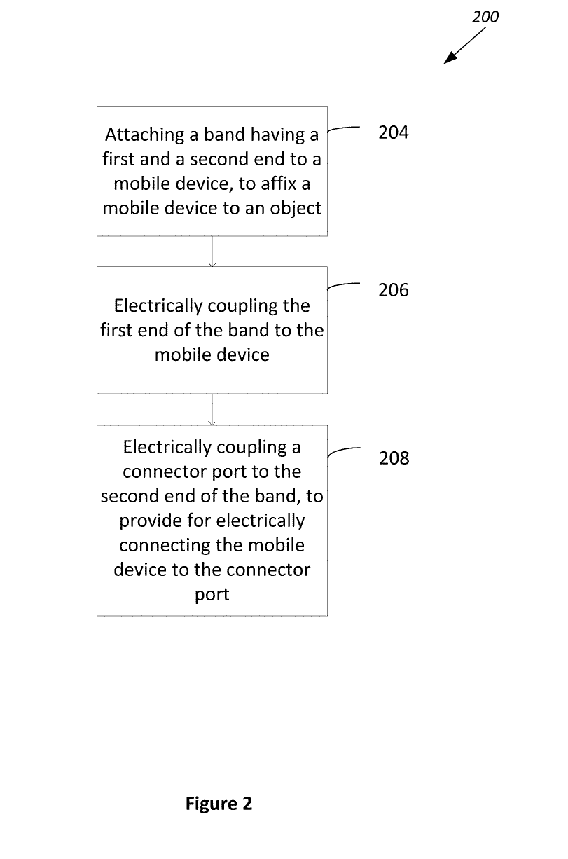

FIG. 2 illustrates a flowchart describing a method for fabricating an embedded port in wearable electronic device, in accordance with embodiments. In embodiments, this method may be used to create a band 100 as shown in FIG. 1.

At block 204, the method may include attaching a band having a first and a second end to a mobile device, to affix the mobile device to an object. In embodiments, the band, such as the band 100 of FIG. 1, may be of various material types used to affix the mobile device to an object. In embodiments where the object may be, for example, a human wrist, the affixed mobile device may, in non-limiting examples, include a smart watch, an exercise tracker, a global positioning system (GPS) device, environment monitor, or a health monitor that may include, in non-limiting examples, heart rate, blood pressure, and/or glucose monitoring. In such examples, the band may be used to directly affix the mobile device to the wrist, such as a snap band that may encircle the wrist, as a non-limiting example. In embodiments the band may be attachable to a second band that may be, in a non-limiting example, attached to another part of the mobile device, and the wrist may be encircled by the two bands. The aforementioned are non-limiting embodiments and examples.

At block 206, the method may include electrically coupling the first end of the band to the mobile device. In embodiments, this may include wiring 102a that runs from within the band or alongside and adjacent to the band that runs from the first end of the band to the mobile device. In embodiments, the band may be constructed out of conductive material, and/or conductive elements that may provide a connection from the first end of the band to the mobile device.

At block 208, the method may include electrically coupling a connector port to the second end of the band, to provide for electrically connecting the mobile device to a connector port. In embodiments, the connector, such as the port 104 (including connector 104a) shown in FIG. 2, may be implemented. In embodiments, the port connection may be USB compliant, secure digital (SD) compliant, peripheral component interconnect express (PCIe) compliant, fiber channel AT attachment (FATA) compliant, Thunderbolt® compliant, or compliant with some other communication and/or charging configuration.

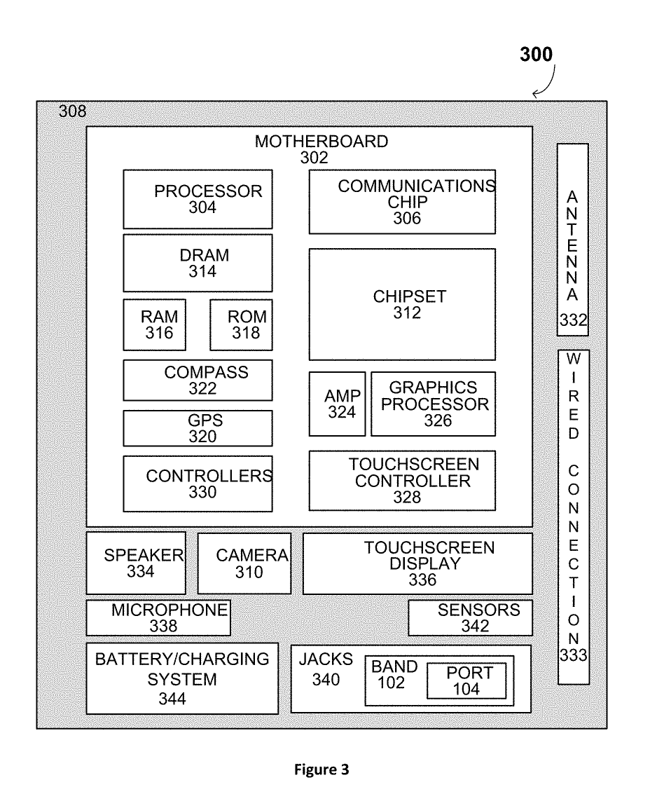

Embodiments of the present disclosure may be implemented into a system using any suitable hardware and/or software to configure as desired. FIG. 3 schematically illustrates a computing device 300 that may be a wearable mobile device, such as device 108 of FIG. 1. The device 300 may be connected with a band, such as band 102. The band 102 may have a first end coupled with the mobile device to affix the mobile device to an object, and a connector port disposed at the second end of the band and electrically coupled through a wired connection 333 with the device 300 to provide a charge for the battery charging system 344 and/or data connection to the motherboard 302 in response to a plug-in of the connector port 104 at the end of band 102 into a charging device.

The computing device 300 may house a board such as motherboard 302 (e.g., in housing 308). The motherboard 302 may include a number of components, including but not limited to a processor 304 and at least one communication chip 306. The processor 304 may be physically and electrically coupled to the motherboard 302. In some implementations, the at least one communication chip 306 may also be physically and electrically coupled to the motherboard 302. In further implementations, the communication chip 306 may be part of the processor 304.

Depending on its applications, computing device 300 may include other components that may or may not be physically and electrically coupled to the motherboard 302. These other components may include, but are not limited to, volatile memory (e.g., dynamic random access memory (DRAM) 314), non-volatile memory (e.g., read only memory (ROM) 318), flash memory, random access memory (RAM) 316, a graphics processor 326, a digital signal processor, a crypto processor, a chipset 312, an antenna 332, a display, a touchscreen display 336, a touchscreen controller 328, a battery/charging system 344, an audio codec, a video codec, a power amplifier 324, a global positioning system (GPS) device 320, a compass 322, microelectromechanical systems (MEMS) sensor 342, a Geiger counter, an accelerometer, a gyroscope, a speaker 334, a camera 310, and a mass storage device (such as a solid-state hard drive), controllers 330, microphone 338, and/or jacks 340 that may include a band 102 with a port 104 connected on the end of the band 102, and so forth. Not all of these components are illustrated in the figure.

The communication chip 306 may enable wireless communications for the transfer of data to and from the computing device 300. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 306 may implement any of a number of wireless standards or protocols, including but not limited to Institute for Electrical and Electronic Engineers (IEEE) standards including WiGig, Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible broadband wireless access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 306 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 406 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 606 may operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication chip 406 may operate in accordance with other wireless protocols in other embodiments.

The computing device 300 may include a plurality of communication chips 306. For instance, a first communication chip 306 may be dedicated to shorter range wireless communications such as WiGig, Wi-Fi and Bluetooth and a second communication chip 306 may be dedicated to longer range wireless communications such as GPS, EDGE, GPRS, CDMA, WiMAX, LTE, EV-DO, and others. In another instance, the first communication chip 306 may be dedicated to wired communications that may be USB compliant, SD compliant, PCIe compliant, FATA compliant, Thunderbolt® compliant, or compliant with some other communication and/or charging configuration.

The processor 304, communication chip 306, chipset 312, memory chips 314, 316, 318, and other devices with chips shown in computing device 300 may contain multi-gate transistors as described herein. The term “processor” may refer to any device or portion of a device that processes electronic data from registers and/or memory to transform that electronic data into other electronic data that may be stored in registers and/or memory.

In various implementations, the computing device 300 may be a mobile computing device in some embodiments. In further implementations, the computing device 400 may be any other electronic device that processes data.

In various implementations, the computing device 300 may be any other electronic device that processes data.

Various components of the computing device 300 shown as being comprised on the motherboard 302 are shown as an illustration of the embodiment and are not intended to be limiting.

### EXAMPLES

Example 1 may be a mobile apparatus, comprising: a mobile device; a band having a first end coupled with the mobile device to affix the mobile device to an object; and a connector port disposed at a second end of the band and electrically coupled with the mobile device, to provide a charge to the mobile device in response to a plug-in of the connector port into a charging device.

Example 2 may include the subject matter of Example 1, wherein the object is one of: a human wrist, a human neck, a human head, a human ankle, a human foot, an article of clothing, an animal, or tangible movable personal property.

Example 3 may include the subject matter of Example 1, wherein the mobile device further includes a battery, the battery to charge when the connector port is connected to the charging device.

Example 4 may include the subject matter of Example 1, wherein the connector port is further to provide communication capabilities between the apparatus and another apparatus, wherein the apparatus further includes a baseband circuitry, to transmit or cause to transmit or to receive or cause to receive data when the connector port is connected to the charging device.

Example 5 may include the subject matter of Example 1, further comprising: a second band with a first and a second end, wherein the first end of the second band is to be connected to the mobile device and the first band is to be attached to the second band, to secure the mobile device to the object.

Example 6 may include the subject matter of Example 5, wherein the first and/or second bands are stretchable.

Example 7 may include the subject matter of Example 1, wherein the connector port is universal serial bus, USB, compliant, secure digital, SD, compliant, peripheral component interconnect express, PCIe, compliant, fiber channel AT attachment, FATA, compliant, or Thunderbolt® compliant.

Example 8 may include the subject matter of Example 1, wherein the connector port is connected to the second end of the band with one or more of a fixed, twistable, bendable, retractable, and compressible connection.

Example 9 the mobile apparatus of Example 1, wherein if, upon connection to a receiving port of the charging device, the connector port is not identified, the connector port is to disconnect the electrical coupling between the connector port and the charging device.

Example 10 may include the subject matter of Example 1, wherein the connector port further includes a identification mechanism that, upon connection to the charging device, is to identify the mobile device to the charging device.

Example 11 may include the subject matter of Example 1, further comprising a cover movably attached to the band, to provide secure cover for the connector port.

Example 12 may be a method of fabricating a chargeable mobile device, comprising: attaching a band having a first and a second end to a mobile device, to affix a mobile device to an object; electrically coupling the first end of the band to the mobile device; electrically coupling a connector port to the second end of the band, to provide for electrically connecting the mobile device to the connector port.

Example 13 may include the subject matter of Example 12, wherein the mobile device further includes a battery to charge when the connector port is connected to a charging device.

Example 14 may include the subject matter of Example 12, wherein the connector port is universal serial bus, USB, compliant, secure digital, SD, compliant, peripheral component interconnect express, PCIe, compliant, fiber channel AT attachment, FATA, compliant, or Thunderbolt® compliant.

Example 15 may include the subject matter of Example 14, wherein the connector port is universal serial bus, USB, compliant, secure digital, SD, compliant, peripheral component interconnect express, PCIe, compliant, fiber channel AT attachment, FATA, compliant, or Thunderbolt® compliant.

Example 16 may include the subject matter of Example 12, wherein the connector port is one of a fixed, twistable, bendable, retractable, or compressible connection.

Example 17 may include the subject matter of Example 12, wherein the connector port has a cover.

Example 18 may be an apparatus, comprising: a band having a first end and a second end; a connector port disposed at the first end of the band connected to and electrically coupled to the band, wherein the band is to affix at least in part to an object, to provide electrical connection between the connector port and the object.

Example 19 may include the subject matter of Example 18, wherein the first end of the band is connected to and electrically coupled to the object.

Example 20 may include the subject matter of Example 19, wherein the object is a first object, wherein the band is a first band, wherein the apparatus further comprises a second band detachably coupled to the first band, to attach the apparatus to a second object.

Example 21 may include the subject matter of Example 20, wherein the first object is a mobile device.

Example 22 may include the subject matter of Example 21, wherein the second object is a human wrist, a human neck, a human head, a human ankle, a human foot, an article of clothing, an animal, or tangible movable personal property.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A mobile apparatus, comprising:
a mobile device;
a band having a first end coupled with the mobile device to affix the mobile device to an object; and
a connector port disposed at a second end of the band and electrically coupled with the mobile device, to provide a charge to the mobile device in response to a plug-in of the connector port into a charging device.

2. The mobile apparatus of claim 1, wherein the object is one of: a human wrist, a human neck, a human head, a human ankle, a human foot, an article of clothing, an animal, or tangible movable personal property.

3. The mobile apparatus of claim 1, wherein the mobile device further includes a battery, the battery to charge when the connector port is connected to the charging device.

4. The mobile apparatus of claim 1, wherein the connector port is further to provide communication capabilities between the apparatus and another apparatus that includes a baseband circuitry to transmit or cause to transmit or to receive or cause to receive data when the connector port is connected to the charging device.

5. The mobile apparatus of claim 1, further comprising:
a second band with a first and a second end, wherein the first end of the second band is to be connected to the mobile device and the first band is to be attached to the second band, to secure the mobile device to the object.

6. The mobile apparatus of claim 5, wherein the first and/or second bands are stretchable.

7. The mobile apparatus of claim 1, wherein the connector port is universal serial bus (USB) compliant, secure digital (SD) compliant, peripheral component interconnect express (PCIe) compliant, fiber channel AT attachment (FATA) compliant, or Thunderbolt® compliant.

8. The mobile apparatus of claim 1, wherein the connector port is connected to the second end of the band with one or more of a fixed, twistable, bendable, retractable, and compressible connection.

9. The mobile apparatus of claim 1, wherein if, upon connection to a receiving port of the charging device, the connector port is not identified, the connector port is to disconnect the electrical coupling between the connector port and the charging device.

10. The mobile apparatus of claim 1, wherein the connector port further includes a identification mechanism that, upon connection to the charging device, is to identify the mobile device to the charging device.

11. The mobile apparatus of claim 1, further comprising a cover movably attached to the band, to provide secure cover for the connector port.

12. A method of fabricating a chargeable mobile device, comprising:
attaching a band having a first and a second end to a mobile device, to affix a mobile device to an object;
electrically coupling the first end of the band to the mobile device;
electrically coupling a connector port to the second end of the band, to provide for electrically connecting the mobile device to the connector port.

13. The method of claim 12, wherein the mobile device further includes a battery to charge when the connector port is connected to a charging device.

14. The method of claim 12, the mobile device further including a baseband circuitry, to transmit or to cause to transmit, or to receive or cause to receive data when the connector port is connected to the charging device.

15. The method of claim 14, wherein the connector port is universal serial bus, USB, compliant, secure digital, SD, compliant, peripheral component interconnect express, PCIe, compliant, fiber channel AT attachment, FATA, compliant, or Thunderbolt® compliant.

16. The method of claim 12, wherein the connector port is one of a fixed, twistable, bendable, retractable, or compressible connection.

17. The method of claim 12, wherein the connector port has a cover.

18. An apparatus, comprising:
a band having a first end and a second end;
a connector port disposed at the first end of the band connected to and electrically coupled to the band, wherein the band is to affix at least in part to an object, to provide electrical connection between the connector port and the object.

19. The apparatus of claim 18, wherein the first end of the band is connected to and electrically coupled to the object.

20. The apparatus of claim 19, wherein the object is a first object, wherein the band is a first band, wherein the apparatus further comprises a second band detachably coupled to the first band, to attach the apparatus to a second object.
